(19) United States
(12) Patent Application Publication
(10) Pub. No.: US 2025/0130375 A1
(43) Pub. Date: Apr. 24, 2025

(54) MANUFACTURING METHOD OF HIGH-PRECISION AND EFFICIENT COUPLING FIBER ARRAY AND FIBER ARRAY

(71) Applicant: WUHAN YILUT TECHNOLOGY CO., LTD., Wuhan (CN)

(72) Inventors: Xiangbo ZHANG, Wuhan (CN); Wenlong CAI, Wuhan (CN)

(21) Appl. No.: 18/991,830

(22) Filed: Dec. 23, 2024

Related U.S. Application Data
(63) Continuation of application No. PCT/CN2023/114147, filed on Aug. 22, 2023.

(30) Foreign Application Priority Data
Mar. 22, 2023 (CN) 2023102844009

(51) Int. Cl. G02B 6/38

(52) U.S. Cl. CPC G02B 6/3874; G02B 6/3861

(57) ABSTRACT

A manufacturing method of high-precision and efficient coupling FA includes: machining circular through-holes on a glass substrate, dividing the glass substrate, and cutting a glass substrate upper surface to obtain an array of V-shaped grooves; peeling a coating layer at an end of each optical fiber, washing and placing them into the array of V-shaped grooves, covering a glass cover to obtain a first intermediate FA; inserting ceramic sleeves into the first intermediate FA to obtain a second intermediate FA; cutting the second intermediate FA to obtain a first FA and a second FA, and grinding and coating; inserting ceramic ferrules into the ceramic sleeves in the first FA, so that an end of the ceramic ferrule is exposed from the first FA, and fixing them; and inserting the end of the ceramic ferrule exposed from the first FA into the second FA for coupling to obtain a finished FA.

### CROSS-REFERENCE TO RELATED APPLICATIONS

This application is a continuation of International Patent Application No. PCT/CN2023/114147, filed Aug. 22, 2023, which claims the priority of Chinese Patent Application No. 202310284400.9, filed Mar. 22, 2023, both of which are herein incorporated by reference in their entirety.

### TECHNICAL FIELD

The disclosure relates to the field of fiber optic communication technologies, and more particularly to a manufacturing method of a high-precision and efficient coupling fiber array (FA) and a FA.

### BACKGROUND

With the development of optical communication technology, the application of FA is more and more extensive. As one of the key application technologies of the FA, fiber coupling is particularly important. Commonly used coupling methods include coupling device embedding, 45° mirror reflection, waveguide grating array, and the like. However, these methods are complex in process, the alignment precision is not high, and the assembly is more cumbersome. For another example, in the related art, the end of the FA is also processed into an optical plane of 45° relative to a fiber axis, and core end surfaces of the two rows of processed FAs are optically coupled. This method has low production efficiency, high processing and equipment costs, and poor coupling precision.

### SUMMARY

The to-be-solved technical problem of the disclosure is to provide a manufacturing method of a high-precision and efficient coupling FA and a FA aiming for the disadvantages in the related art.

The technical solution of the disclosure to solve the above technical problem is as follows. A manufacturing method of a high-precision and efficient coupling FA includes:
step S1, machining circular through-holes adapted to ceramic sleeves on a glass substrate, dividing the glass substrate with the circular through-holes according to a preset size, and cutting an upper surface of the glass substrate with the preset size along a direction of the circular through-holes to obtain an array of V-shaped grooves;
step S2, peeling a coating layer at an end of each of optical fibers, washing the optical fibers to obtain washed optical fibers, placing the washed optical fibers into the array of V-shaped grooves, covering the glass substrate placed with the washed optical fibers by a glass cover, and fixing the glass substrate and the glass cover by adhesion to obtain a first intermediate FA;
step S3, inserting the ceramic sleeves into the circular through-holes in the first intermediate FA completely, and fixing the ceramic sleeves with the circular through-holes in the first intermediate FA by adhesion to obtain a second intermediate FA;
step S4, cutting the second intermediate FA to obtain a first FA and a second FA, grinding end surfaces of the optical fibers on the first FA and the second FA, and coating the ground end surfaces of the optical fibers on the first FA and the second FA;
step S5, inserting ceramic ferrules matched with the ceramic sleeves into the ceramic sleeves in the first FA, to make an end of each of the ceramic ferrules be exposed from the first FA, and fixing the ceramic ferrules with the ceramic sleeves in the first FA by adhesion; and
step S6, inserting the end of each of the ceramic ferrules exposed from the first FA into the ceramic sleeves in the second FA completely, and coupling the end of each of the ceramic ferrules exposed from the first FA with the ceramic sleeves in the second FA, to thereby obtain a finished FA.

The beneficial effects of the disclosure are as follows. In the manufacturing method of the high-precision and efficient coupling FA, a same glass substrate is divided into two parts, and the ceramic sleeves and the ceramic ferrules disposed in the circular through-holes are in precision fit, so that a coupling precision of the first FA and the second FA is greatly improved. A mechanical insertion and extraction of the ceramic sleeves and the ceramic ferrules can achieve repeated use of components, and can be flexibly disassembled and assembled. Meanwhile, an angle, a size, and a number of channels of the FA are not limited, which can be combined freely according to needs.

On the basis of the aforementioned technical solution, the disclosure can also be improved as follows.

In an embodiment, in the step S1, a number of the circular through-holes is at least two, and adjacent two of the circular through-holes are arranged in parallel at interval.

The beneficial effects of the above further solution are as follows. Through setting at least two circular through-holes, at least two ceramic sleeves and ceramic ferrules can be synchronously fitted, so that the first FA and the second FA after cutting can be more accurately aligned during the coupling process, thereby avoiding displacement and angular rotation between the first FA and the second FA other than an axial direction of each ceramic ferrule.

In an embodiment, a length of each of the ceramic sleeves is not greater than a length of each of the circular through-holes, and a length of each of the ceramic ferrules is not greater than the length of each of the circular through-holes.

The beneficial effects of the above further solution are as follows. Through setting the length of each of the ceramic sleeves no greater than the length of each of the circular through-holes, and the length of each of the ceramic ferrules no greater than the length of each of the circular through-holes, which can ensure that the ceramic sleeves and the ceramic ferrules do not expose from the glass substrate after they are fully inserted into the circular through-holes. On the one hand, it is convenient for subsequent combination between the FA with other optical devices, and on the other hand, it can ensure the appearance of the product.

In an embodiment, in the step 2, after covering the glass substrate placed with the washed optical fibers with the glass cover, the fixing the glass substrate and the glass cover by adhesion to obtain a first intermediate FA, includes:
step S21, filling the array of V-shaped grooves with ultraviolet (UV) glue, and irradiating the UV glue filled in the array of V-shaped grooves by an UV light source to solidify the UV glue, so that the optical fibers are fixed on the array of V-shaped grooves; and
step S22, filling a step on a side of the upper surface of the glass substrate with acrylate glue, and irradiating the acrylate glue filled in the step on the side of the upper surface of the glass substrate by the UV light source to solidify the acrylate glue.

The beneficial effects of the above further solution are as follows. Through filling the array of V-shaped grooves with the UV glue, and irradiating to solidify the UV glue, the optical fibers can be conveniently fixed in the array of V-shaped grooves. Through filling the step on the side of the upper surface of the glass substrate with the acrylate glue, and irradiating to solidify the acrylate glue, the positions of the optical fibers corresponding to the step are effectively protected.

In an embodiment, in the step 2, after covering the glass substrate placed with the washed optical fibers with the glass cover, the fixing the glass substrate and the glass cover by adhesion further includes:
step S23, placing the fixed glass substrate and glass cover into an aging box and a temperature cycle box for processing.

The beneficial effects of the above further solution are as follows. Through placing the fixed glass substrate and glass cover into the aging box, the solidification of the UV glue can be accelerated, and the connection between the glass substrate and the glass cover can be more stable. Through placing the fixed glass substrate and glass cover into the temperature cycle box for processing, the stress of the UV glue can be released through repeated thermal expansion and contraction, and the adhesion effect of the UV glue can be further improved.

In an embodiment, in the step S4, before or after cutting the second intermediate FA, the first FA and the second FA corresponding to a same second intermediate FA are marked.

The beneficial effects of the above further solution are as follows. Through marking the first FA and the second FA corresponding to the same second intermediate FA, which can ensure that the first FA and the second FA corresponding to the same second intermediate FA can achieve high precision during coupling, to achieve perfect matching.

In an embodiment, in the step S5, lengths of the ends of the ceramic ferrules exposed from the first FA are the same.

The beneficial effects of the above further solution are as follows. Through making the lengths of the ends of the ceramic ferrules exposed from the first FA be the same, which is conducive to the smooth coupling of the first FA and the second FA, and reduces the possibility of occurring the displacement and angular rotation between the first FA and the second FA other than the axial direction of each ceramic ferrule.

The disclosure further provides a high-precision and efficient coupling FA, which is manufactured by using the manufacturing method of the high-precision and efficient coupling FA.

### BRIEF DESCRIPTION OF DRAWINGS

FIG. 1 illustrates a schematic cross-sectional diagram of a glass substrate machined with circular through-holes according to an embodiment of the disclosure.

FIG. 2 illustrates a schematic cross-sectional diagram of a glass substrate machined with an array of V-shaped grooves according to an embodiment of the disclosure.

FIG. 3 illustrates a schematic cross-sectional diagram of a glass substrate placed with optical fibers according to an embodiment of the disclosure.

FIG. 4 illustrates a schematic cross-sectional diagram of a first intermediate FA according to an embodiment of the disclosure.

FIG. 5 illustrates a schematic cross-sectional diagram of a second intermediate FA according to an embodiment of the disclosure.

FIG. 6 illustrates a schematic structural diagram from a front perspective of the second intermediate FA according to an embodiment of the disclosure.

FIG. 7 illustrates a schematic structural diagram from a front perspective of the second intermediate FA after cutting, grinding and coating according to an embodiment of the disclosure.

FIG. 8 illustrates a schematic structural diagram from a front perspective of ceramic ferrules inserted into the first FA according to an embodiment of the disclosure.

FIG. 9 illustrates a schematic three-dimensional structural diagram of the ceramic ferrules inserted into the first FA according to an embodiment of the disclosure.

FIG. 10 illustrates a schematic diagram of a process of coupling the first FA and the second FA according to an embodiment of the disclosure.

FIG. 11 illustrates a schematic structural diagram from a front perspective of a finished FA after coupling the first FA and the second FA according to an embodiment of the disclosure.

FIG. 12 illustrates a schematic exploded diagram of a high-precision and efficient coupling FA according to an embodiment of the disclosure.

In the drawings, list of components represented by each reference sign is as follows:
1—glass substrate; 2—optical fiber; 3—glass cover; 4—acrylate glue; 5—first intermediate FA; 6—second intermediate FA; 7—first FA; 8—second FA; 9—ceramic sleeve; 10—ceramic ferrule; 11—finished FA.

### DETAILED DESCRIPTION OF EMBODIMENTS

The principles and features of the disclosure are described below in conjunction with the drawings, and the embodiments given are only used to explain the disclosure, and are not intended to limit the scope of the disclosure.

The disclosure provides a manufacturing method of a high-precision and efficient coupling FA, including the following steps S1-S6.

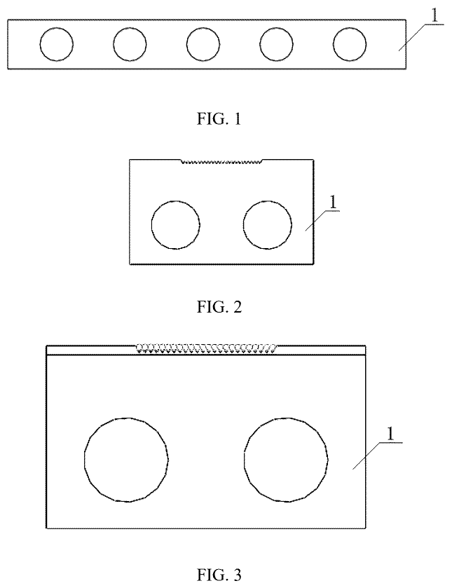

In step S1, circular through-holes adapted to ceramic sleeves 9 are machined on a glass substrate 1, as shown in FIG. 1. The glass substrate 1 machined with the circular through-holes is divided according to a preset size, and an upper surface of the glass substrate 1 with the preset size is cut along a direction of the circular through-holes to obtain an array of V-shaped grooves.

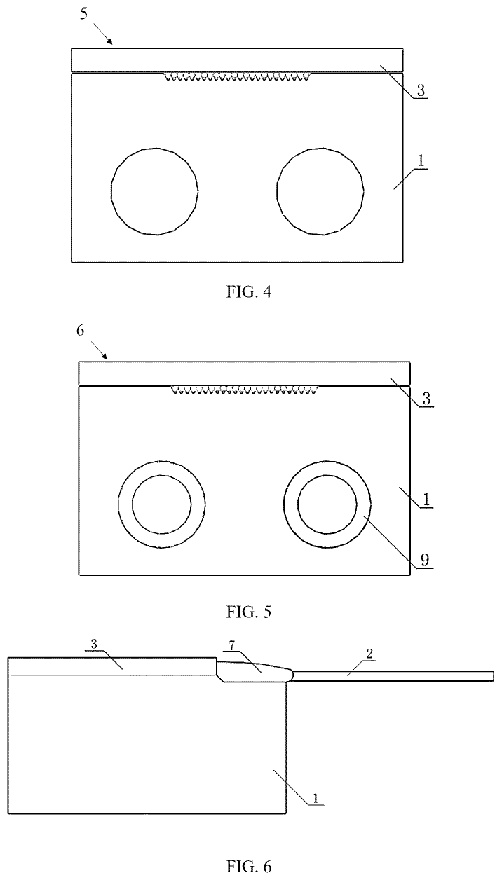

In step S2, a coating layer at an end of each optical fiber 2 is peeled, and the optical fibers 2 are washed and placed into the array of V-shaped grooves, as shown in FIG. 3. The glass substrate 1 placed with the optical fibers 2 is covered by a glass cover 3, and the glass substrate 1 is fixed with the glass cover 3 by adhesion to obtain a first intermediate FA, as shown in FIG. 4.

In step S3, the ceramic sleeves 9 are inserted into the circular through-holes in the first intermediate FA 5 completely, and the ceramic sleeves 9 are fixed with the circular through-holes in the first intermediate FA 5 by adhesion to obtain a second intermediate FA 6, as shown in FIG. 5 and FIG. 6.

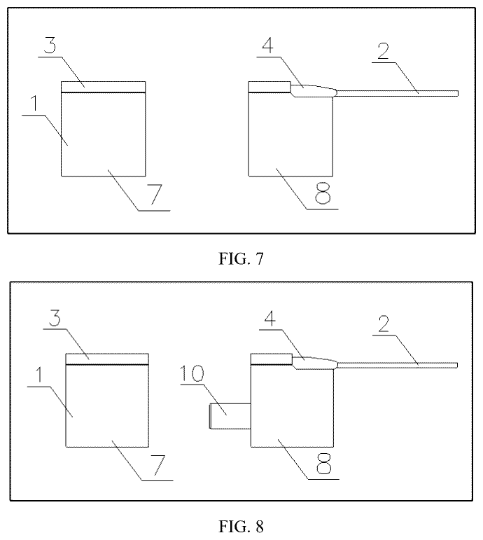

In step S4, the second intermediate FA 6 is cut to obtain a first FA 7 and a second FA 8. End surfaces of the optical fibers 2 on the first FA 7 and the second FA 8 are ground, and the ground end surfaces of the optical fibers 2 on the first FA 7 and the second FA 8 are coated, as shown in FIG. 7.

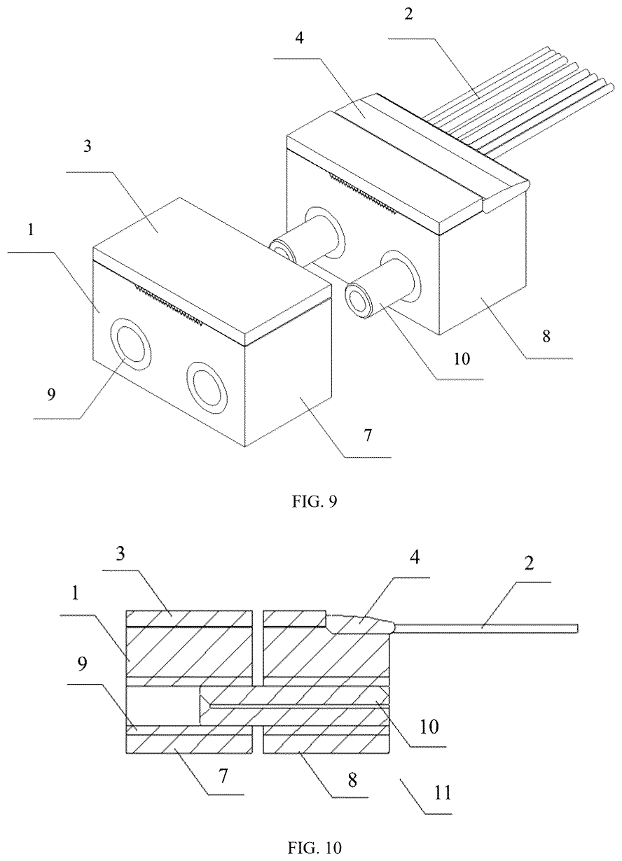

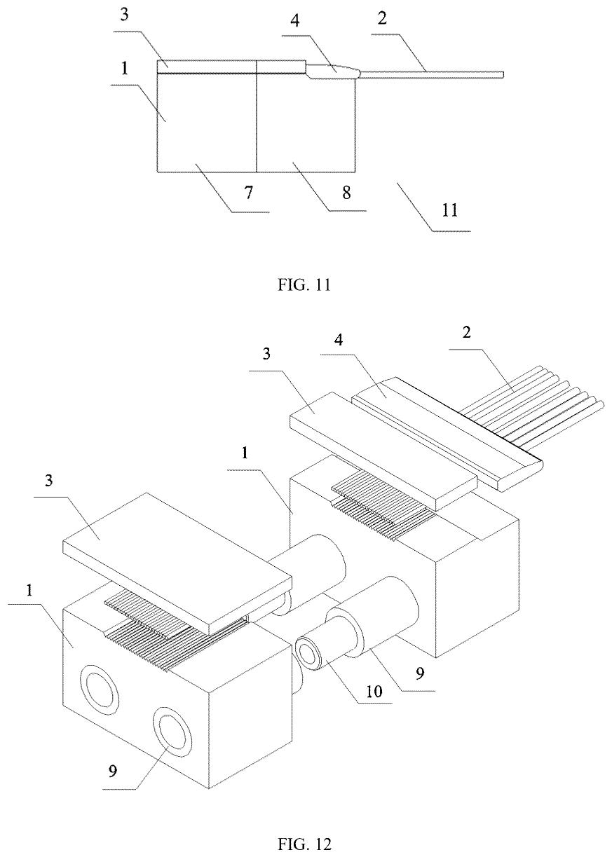

In step 5, ceramic ferrules 10 matched with the ceramic sleeves 9 are inserted into the ceramic sleeves 9 in the first FA 7, so that an end of each of the ceramic ferrules 10 is exposed from the first FA 7, and the ceramic ferrules 10 are fixed with the ceramic sleeves 9 in the first FA 7 by adhesion, as shown in FIG. 8 and FIG. 9.

In step S6, the end of each of the ceramic ferrules 10 exposed from the first FA 7 is inserted into the ceramic sleeves 9 in the second FA 8 completely, and the end of each of the ceramic ferrules 10 exposed from the first FA 7 is coupled with the ceramic sleeves 9 in the second FA 8 to thereby obtain a finished FA 11.

In the manufacturing method of the high-precision and efficient coupling FA, a same glass substrate 1 is divided into two parts, and the ceramic sleeves 9 and the ceramic ferrules 10 disposed in the circular through-holes are in precision fit, so that a coupling precision of the first FA 7 and the second FA 8 is greatly improved. A mechanical insertion and extraction of the ceramic sleeves 9 and the ceramic ferrules 10 can achieve repeated use of components, and can be flexibly disassembled and assembled. Meanwhile, an angle, a size, and a number of channels of the FA are not limited, which can be combined freely according to needs.

In one or more embodiments of the disclosure, in the step S1, a number of the circular through-holes is at least two, and adjacent two of the circular through-holes are arranged in parallel at interval. Through setting at least two circular through-holes, at least two ceramic sleeves 9 and ceramic ferrules 10 can be synchronously fitted, so that the first FA 7 and the second FA 8 after cutting can be more accurately aligned during the coupling process, thereby avoiding displacement and angular rotation between the first FA 7 and the second FA 8 other than an axial direction of each ceramic ferrule 10.

In practice, in order to facilitate the smooth insertion of the ceramic sleeves 9 into the circular through-holes, a diameter of each circular through-hole is 0.01 millimeters (mm) greater than an outer diameter of each of the ceramic sleeves 9.

In order to ensure the cut precision of the glass substrate 1, in the embodiments of the disclosure, a high-precision cutting machine is used to divide the glass substrate 1 with the circular through-holes according to the preset size, and the upper surface of the glass substrate 1 after dividing is cut along the direction of the circular through-holes to obtain the array of V-shaped grooves. After obtaining the array of V-shaped grooves, the glass substrate 1 with the array of V-shaped grooves is washed for later use.

Optionally, in one or more embodiments of the disclosure, a length of each of the ceramic sleeves 9 is not greater than a length of each of the circular through-holes, and a length of each of the ceramic ferrules 10 is not greater than the length of each of the circular through-holes. Through setting the length of each of the ceramic sleeves 9 no greater than the length of each of the circular through-holes, and the length of each of the ceramic ferrules 10 no greater than the length of each of the circular through-holes, which can ensure that the ceramic sleeves 9 and the ceramic ferrules 10 do not expose from the glass substrate 1 after they are fully inserted into the circular through-holes. On the one hand, it is convenient for subsequent combination between the FA with other optical devices, and on the other hand, it can ensure the appearance of the product.

In one or more embodiments of the disclosure, in the step S2, after the glass substrate 1 placed with the optical fibers 2 is covered with the glass cover 3, the glass substrate 1 is fixed with the glass cover 3 by adhesion, including the following steps S21-S22.

In step S21, the array of V-shaped grooves is filled with UV glue, and the UV glue filled in the array of V-shaped grooves is irradiated by an UV light source to solidify the UV glue, so that the optical fibers 2 are fixed on the array of V-shaped grooves.

In step S22, a step on a side of the upper surface of the glass substrate 1 is filled with acrylate glue 4, and the acrylate glue 4 filled in the step on the side of the upper surface of the glass substrate 1 is irradiated by the UV light source to solidify the acrylate glue 4.

Through filling the array of V-shaped grooves with the UV glue, and irradiating to solidify the UV glue, the optical fibers 2 can be conveniently fixed in the array of V-shaped grooves. Through filling the step on the side of the upper surface of the glass substrate 1 with the acrylate glue, and irradiating to solidify the acrylate glue 4, the positions of the optical fibers 2 corresponding to the step are effectively protected.

In one or more embodiments of the disclosure, in the step S2, after the glass substrate 1 placed with the optical fibers 2 is covered with the glass cover 3, and the glass substrate 1 is fixed with the glass cover 3 by adhesion, which further includes the following step S23.

In step S23, the fixed glass substrate 1 and glass cover 3 are placed into an aging box and a temperature cycle box for processing.

Through placing the fixed glass substrate 1 and glass cover 3 into the aging box, the solidification of the UV glue can be accelerated, and the connection between the glass substrate 1 and the glass cover 3 can be more stable. Through placing the fixed glass substrate 1 and glass cover 3 into the temperature cycle box for processing, the stress of the UV glue can be released through repeated thermal expansion and contraction, and the adhesion effect of the UV glue can be further improved.

In practice, after processing in the aging box and the temperature cycle box, the product is taken out for inspection to check whether the appearance of the product is intact and whether the adhesion between the parts is firm.

In one or more embodiments of the disclosure, after the ceramic sleeves 9 are inserted into the circular through-holes in the first intermediate FA 5 completely, the UV glue is used to adhere the ceramic sleeves 9 and the circular through-holes in the first intermediate FA 5, and the UV light source is used to irradiate the UV glue to solidify the UV glue.

Optionally, in one or more embodiments of the disclosure, in the step S4, before or after cutting the second intermediate FA 6, the first FA 7 and the second FA 8 corresponding to a same second intermediate FA 6 are marked. Through marking the first FA 7 and the second FA 8 corresponding to the same second intermediate FA 6, which can ensure that the first FA 7 and the second FA 8 corresponding to the same second intermediate FA 6 can achieve high precision during coupling, to achieve perfect matching.

In addition, in the embodiments of the disclosure, in the step S4, the end surfaces of the optical fibers 2 are ground and coated. Here, generally, in the first FA 7 and the second FA 8, the end surfaces of the optical fibers 2 in one of the first FA 7 and the second FA 8 are coated with a transmissive layer, and the end surfaces of the optical fibers 2 in the other of the first FA 7 and the second FA 8 are coated with a reflective film layer.

It should be pointed out that due to small end surfaces of the optical fibers 2 after grinding, it is not very convenient to coat the end surfaces of the optical fibers 2 alone during coating. In practice, a cutting surface of the glass substrate 1 in each of the first FA 7 and the second FA 8 and the end surfaces of the optical fibers 2 are coated together to improve the coating efficiency and effect.

Optionally, in one or more embodiments of the disclosure, in the step S5, lengths of the ends of the ceramic ferrules 10 exposed from the first FA 7 are the same. Through making the lengths of the ends of the ceramic ferrules 10 exposed from the first FA 7 be the same, which is conducive to the smooth coupling of the first FA 7 and the second FA 8, and reduces the possibility of occurring the displacement and angular rotation between the first FA 7 and the second FA 8 other than the axial direction of each ceramic ferrule 10.

In one or more embodiments of the disclosure, in the step S5, after inserting the ceramic ferrules 10 into the ceramic sleeves 9 in the first FA 7, the UV glue is applied in gaps between the ceramic sleeves 9 and the ceramic ferrules 10, and the UV light source is used to irradiate and solidify the UV glue, to thereby fix the ceramic sleeves 9 and the ceramic ferrules 10.

The disclosure further provides a high-precision and efficient coupling FA, which is manufactured by using the manufacturing method of the high-precision and efficient coupling FA.

In the embodiments of the disclosure, the FA manufactured by the manufacturing method of the high-precision and efficient coupling FA is tested, and the testing method is as follows.
1. A pigtail of the first FA 7 is welded with an end of a testing line, and the other end of the testing line is connected to a light source. An end surface of a FA of the first FA 7 is aligned to a light receiving photo detector (PD) of a power meter, and a loss of the power meter is reset.
2. The first FA 7 is combined with the second FA 8, and an end surface of a FA of the second FA is aligned to the light receiving PD. A distance between the first FA 7 and the second FA 8 is fine-tuned until a value displayed by the power meter is the smallest, to obtain insertion loss (IL) and return loss (RL) of testing. The testing results are shown in Table 1 and Table 2, Table 1 is a testing result of a grinding surface angle of 0°, and Table 2 is a testing result of a grinding surface angle of 8°.

TABLE 1

| Serial number (SN) | IL (decibel abbreviated as dB) | RL (dB) |
|---|---|---|
| 1 | 0.02 | 30.4 |
| 2 | 0.08 | 31.4 |
| 3 | 0.05 | 34.2 |
| 4 | 0.07 | 27.4 |
| 5 | 0.03 | 25.8 |
| 6 | 0.03 | 31.5 |
| 7 | 0.02 | 29.8 |
| 8 | 0.09 | 30.7 |
| 9 | 0.05 | 33.7 |
| 10 | 0.06 | 31.1 |
| 11 | 0.02 | 29.3 |
| 12 | 0.08 | 33.4 |
| 13 | 0.05 | 29.5 |
| 14 | 0.04 | 33.8 |
| 15 | 0.06 | 31.1 |
| 16 | 0.06 | 34.8 |
| 17 | 0.05 | 32.2 |
| 18 | 0.03 | 35.6 |
| 19 | 0.07 | 28.2 |
| 20 | 0.04 | 28.7 |

TABLE 2

| SN | IL (dB) | RL (dB) |
|---|---|---|
| 1 | 0.09 | 56.4 |
| 2 | 0.03 | 58.8 |
| 3 | 0.05 | 58.2 |
| 4 | 0.08 | 61.6 |
| 5 | 0.04 | 59.8 |
| 6 | 0.06 | 57.9 |
| 7 | 0.09 | 61.1 |
| 8 | 0.08 | 61.5 |
| 9 | 0.06 | 56.9 |
| 10 | 0.04 | 56.1 |
| 11 | 0.03 | 61.8 |
| 12 | 0.07 | 58.3 |
| 13 | 0.05 | 61.7 |
| 14 | 0.03 | 62.4 |
| 15 | 0.04 | 57.6 |
| 16 | 0.05 | 59.3 |
| 17 | 0.07 | 60.2 |
| 18 | 0.05 | 57.4 |
| 19 | 0.06 | 62.5 |
| 20 | 0.08 | 59.7 |

It can be seen from Table 1 and Table 2 that compared to traditional IL (0.2 dB to 0.5 dB), the FA manufactured by the manufacturing method of the high-precision and efficiency coupling FA of the disclosure greatly improve the coupling efficiency, while greatly reduces the IL, and improves RL.

The manufacturing method of the high-precision and efficiency coupling FA and the FA of the disclosure have the following advantages and effects.
1. High alignment precision can be achieved, the alignment precision is guaranteed to be within ±0.5 microns (m), which is guaranteed by the following innovations.
(1) Through dividing the same FA into two parts and recombining, the coupling precision of the channels of the two parts of FA is guaranteed.
(2) Through a tight fit of high-precision ceramic ferrule and ceramic sleeve, the combination precision of the two parts is guaranteed.
2. The mechanical insertion and extraction of the ceramic sleeves and the ceramic ferrules can achieve repeated use of components, and can be flexibly disassembled and assembled.
3. Many types of optical devices such as lenses or isolators can be combined on the FA to achieve different functions and meet more diverse design and use requirements.
4. Materials and internal structures such as angle, size, number of channels, coating conditions, fiber types and connector types of the FA are not limited, which can be combined freely according to needs.
5. The mechanical insertion and extraction replaces the dispensing coupling process, which greatly improves the plasticity and use of the product.

The above description is merely some of the embodiments of the disclosure and is not intended to limit the disclosure. Any modifications, equivalent substitutions and improvements made within the spirit and principles of the disclosure should be included in the scope of protection of the disclosure.

What is claimed is:

1. A manufacturing method of a fiber array (FA), comprising:
step S1, machining circular through-holes adapted to ceramic sleeves (9) on a glass substrate (1), dividing the glass substrate (1) with the circular through-holes according to a preset size, and cutting an upper surface of the glass substrate (1) with the preset size along a direction of the circular through-holes to obtain an array of V-shaped grooves;
step S2, peeling a coating layer at an end of each of optical fibers (2), washing the optical fibers (2) to obtain washed optical fibers (2), placing the washed optical fibers (2) into the array of V-shaped grooves, covering the glass substrate (1) placed with the washed optical fibers (2) by a glass cover (3), and fixing the glass substrate (1) and the glass cover (3) by adhesion to obtain a first intermediate FA (5);
step S3, inserting the ceramic sleeves (9) into the circular through-holes in the first intermediate FA (5) completely, and fixing the ceramic sleeves (9) with the circular through-holes in the first intermediate FA (5) by adhesion to obtain a second intermediate FA (6);
step S4, cutting the second intermediate FA (6) to obtain a first FA (7) and a second FA (8), grinding end surfaces of the optical fibers (2) on the first FA (7) and the second FA (8), and coating the ground end surfaces of the optical fibers (2) on the first FA (7) and the second FA (8);
step S5, inserting ceramic ferrules (10) matched with the ceramic sleeves (9) into the ceramic sleeves (9) in the first FA (7) to make an end of each of the ceramic ferrules (10) be exposed from the first FA (7), and fixing the ceramic ferrules (10) with the ceramic sleeves (9) in the first FA (7) by adhesion; and
step S6, inserting the end of each of the ceramic ferrules (10) exposed from the first FA (7) into the ceramic sleeves (9) in the second FA (8) completely, and coupling the end of each of the ceramic ferrules (10) exposed from the first FA (7) with the ceramic sleeves (9) in the second FA (8), to thereby obtain a finished FA (11).

2. The manufacturing method of the FA as claimed in claim 1, wherein in the step S1, a number of the circular through-holes is at least two, and adjacent two of the circular through-holes are arranged in parallel at interval.

3. The manufacturing method of the FA as claimed in claim 1, wherein a length of each of the ceramic sleeves (9) is not greater than a length of each of the circular through-holes, and a length of each of the ceramic ferrules (10) is not greater than the length of each of the circular through-holes.

4. The manufacturing method of the FA as claimed in claim 1, wherein in the step S2, after covering the glass substrate (1) placed with the washed optical fibers (2) with the glass cover (3), the fixing the glass substrate (1) and the glass cover (3) by adhesion to obtain a first intermediate FA (5) comprises:
step S21, filling the array of V-shaped grooves with ultraviolet (UV) glue, and irradiating the UV glue filled in the array of V-shaped grooves by an UV light source to solidify the UV glue, to thereby fix the optical fibers (2) on the array of V-shaped grooves; and
step S22, filling a step on a side of the upper surface of the glass substrate (1) with acrylate glue (4), and irradiating the acrylate glue (4) filled in the step on the side of the upper surface of the glass substrate (1) by the UV light source to solidify the acrylate glue (4).

5. The manufacturing method of the FA as claimed in claim 4, wherein in the step S2, after covering the glass substrate (1) placed with the washed optical fibers (2) with the glass cover (3), the fixing the glass substrate (1) and the glass cover (3) by adhesion further comprises:
step S23, placing the fixed glass substrate (1) and glass cover (3) onto an aging box and a temperature cycle box for processing.

6. The manufacturing method of the FA as claimed in claim 1, wherein in the step S4, before or after cutting the second intermediate FA (6), the first FA (7) and the second FA (8) corresponding to a same second intermediate FA (6) are marked.

7. The manufacturing method of the FA as claimed in claim 1, wherein in the step S5, lengths of the ends of the ceramic ferrules (10) exposed from the first FA (7) are the same.

8. The manufacturing method of the FA as claimed in claim 1, wherein a diameter of each of the circular through-holes is 0.01 mm greater than an outer diameter of each of the ceramic sleeves (9).

9. The manufacturing method of the FA as claimed in claim 1, wherein in the step S3, the fixing the ceramic sleeves (9) with the circular through-holes in the first intermediate FA (5) by adhesion to obtain a second intermediate FA (6), specifically comprises:
adhering the ceramic sleeves (9) and the circular through-holes in the first intermediate FA (5) by using UV glue, and irradiating the UV glue by an UV light source to solidify the UV glue.

10. The manufacturing method of the FA as claimed in claim 1, wherein in the step S5, the fixing the ceramic ferrules (10) with the ceramic sleeves (9) in the first FA (7) by adhesion, specifically comprises:
filling gaps between the ceramic sleeves (9) and the ceramic ferrules (10) with UV glue, and irradiating the UV glue filled in the gaps between the ceramic sleeves (9) and the ceramic ferrules (10) by an UV light source to solidify the UV glue.

11. An FA, wherein the FA is manufactured by a manufacturing method of the FA; and the manufacturing method comprises:
step S1, machining circular through-holes adapted to ceramic sleeves (9) on a glass substrate (1), dividing the glass substrate (1) with the circular through-holes according to a preset size, and cutting an upper surface of the glass substrate (1) with the preset size along a direction of the circular through-holes to obtain an array of V-shaped grooves;
step S2, peeling a coating layer at an end of each of optical fibers (2), washing the optical fibers (2) to obtain washed optical fibers (2), placing the washed optical fibers (2) into the array of V-shaped grooves, covering the glass substrate (1) placed with the washed optical fibers (2) by a glass cover (3), and fixing the glass substrate (1) and the glass cover (3) by adhesion to obtain a first intermediate FA (5);
step S3, inserting the ceramic sleeves (9) into the circular through-holes in the first intermediate FA (5) completely, and fixing the ceramic sleeves (9) with the circular through-holes in the first intermediate FA (5) by adhesion to obtain a second intermediate FA (6);
step S4, cutting the second intermediate FA (6) to obtain a first FA (7) and a second FA (8), grinding end surfaces of the optical fibers (2) on the first FA (7) and the second FA (8), and coating the ground end surfaces of the optical fibers (2) on the first FA (7) and the second FA (8);
step S5, inserting ceramic ferrules (10) matched with the ceramic sleeves (9) into the ceramic sleeves (9) in the first FA (7) to make an end of each of the ceramic ferrules (10) be exposed from the first FA (7), and fixing the ceramic ferrules (10) with the ceramic sleeves (9) in the first FA (7) by adhesion; and
step S6, inserting the end of each of the ceramic ferrules (10) exposed from the first FA (7) into the ceramic sleeves (9) in the second FA (8) completely, and coupling the end of each of the ceramic ferrules (10) exposed from the first FA (7) with the ceramic sleeves (9) in the second FA (8), to thereby obtain a finished FA (11).

12. The FA as claimed in claim 11, wherein a number of the circular through-holes is at least two, and adjacent two of the circular through-holes are arranged in parallel at interval.

13. The FA as claimed in claim 11, wherein a length of each of the ceramic sleeves (9) is not greater than a length of each of the circular through-holes, and a length of each of the ceramic ferrules (10) is not greater than the length of each of the circular through-holes.

14. The FA as claimed in claim 11, wherein lengths of the ends of the ceramic ferrules (10) exposed from the first FA (7) are the same.

15. The FA as claimed in claim 11, wherein a diameter of each of the circular through-holes is 0.01 mm greater than an outer diameter of each of the ceramic sleeves (9).

16. A manufacturing method of a FA, comprising:
step S1, machining at least two circular through-holes adapted to ceramic sleeves (9) on a glass substrate (1), dividing the glass substrate (1) with the at least two circular through-holes according to a preset size, and cutting an upper surface of the glass substrate (1) with the preset size along a direction of the at least two circular through-holes to obtain an array of V-shaped grooves; wherein adjacent two of the at least two circular through-holes are arranged at parallel intervals, and a length of each of the ceramic sleeves (9) is not greater than a length of each of the at least two circular through-holes;
step S2, peeling a coating layer at an end of each of optical fibers (2), washing the optical fibers (2) to obtain washed optical fibers (2), placing the washed optical fibers (2) into the array of V-shaped grooves, covering the glass substrate (1) placed with the washed optical fibers (2) by a glass cover (3), and fixing the glass substrate (1) and the glass cover (3) by adhesion to obtain a first intermediate FA (5);
step S3, inserting the ceramic sleeves (9) into the at least two circular through-holes in the first intermediate FA (5) completely, and fixing the ceramic sleeves (9) with the at least two circular through-holes in the first intermediate FA (5) by adhesion to obtain a second intermediate FA (6);
step S4, cutting the second intermediate FA (6) to obtain a first FA (7) and a second FA (8), grinding end surfaces of the optical fibers (2) on the first FA (7) and the second FA (8), and coating the ground end surfaces of the optical fibers (2) on the first FA (7) and the second FA (8);
step S5, inserting ceramic ferrules (10) matched with the ceramic sleeves (9) into the ceramic sleeves (9) in the first FA (7), to make an end of each of the ceramic ferrules (10) be exposed from the first FA (7), and fixing the ceramic ferrules (10) with the ceramic sleeves (9) in the first FA (7) by adhesion; wherein a length of each of the ceramic ferrules (10) is not greater than the length of each of the circular through-holes; and
step S6, inserting the end of each of the ceramic ferrules (10) exposed from the first FA (7) into the ceramic sleeves (9) in the second FA (8) completely, and coupling the end of each of the ceramic ferrules (10) exposed from the first FA (7) with the ceramic sleeves (9) in the second FA (8), to thereby obtain a finished FA (11).

17. The manufacturing method of the FA as claimed in claim 16, wherein in the step S2, after covering the glass substrate (1) placed with the washed optical fibers (2) with the glass cover (3), the fixing the glass substrate (1) and the glass cover (3) by adhesion to obtain a first intermediate FA (5) comprises:
step S21, filling the array of V-shaped grooves with ultraviolet (UV) glue, and irradiating the UV glue filled in the array of V-shaped grooves by an UV light source to solidify the UV glue, to thereby fix the optical fibers (2) on the array of V-shaped grooves; and
step S22, filling a step on a side of the upper surface of the glass substrate (1) with acrylate glue (4), and irradiating the acrylate glue (4) filled in the step on the side of the upper surface of the glass substrate (1) by the UV light source to solidify the acrylate glue (4).

18. The manufacturing method of the FA as claimed in claim 17, wherein in the step S2, after covering the glass substrate (1) placed with the washed optical fibers (2) with the glass cover (3), the fixing the glass substrate (1) and the glass cover (3) by adhesion further comprises:
step S23, placing the fixed glass substrate (1) and glass cover (3) onto an aging box and a temperature cycle box for processing.

19. The manufacturing method of the FA as claimed in claim 16, wherein in the step S4, before or after cutting the second intermediate FA (6), the first FA (7) and the second FA (8) corresponding to a same second intermediate FA (6) are marked.

20. The manufacturing method of the FA as claimed in claim 18, wherein in the step S3, the fixing the ceramic sleeves (9) with the at least two circular through-holes in the first intermediate FA (5) by adhesion to obtain a second intermediate FA (6), specifically comprises:
adhering the ceramic sleeves (9) and the at least two circular through-holes in the first intermediate FA (5) by using the UV glue, and irradiating the UV glue by the UV light source to solidify the UV glue.
